(19) United States
(12) Patent Application Publication
(10) Pub. No.: US 2025/0289058 A1
(43) Pub. Date: Sep. 18, 2025

(54) HYBRID SYSTEM FOR THERMAL ADDITIVE MANUFACTURING

(71) Applicant: Yuliya McAnany, Wayne, PA (US)

(72) Inventor: John D. McAnany, Wayne, PA (US)

(73) Assignee: Yuliya McAnany, Wayne, PA (US)

(21) Appl. No.: 19/078,226

(22) Filed: Mar. 12, 2025

Related U.S. Application Data
(60) Provisional application No. 63/564,474, filed on Mar. 12, 2024.

(51) Int. Cl. B22F 10/64; B22F 10/18; B22F 12/53; B33Y 30/00; B33Y 40/20

(52) U.S. Cl. CPC B22F 10/64; B22F 10/18; B22F 12/53; B33Y 30/00; B33Y 40/20; B22F 2201/10; B22F 2301/35; B22F 2304/10

(57) ABSTRACT

Additive manufacturing systems and associated methods and build materials are described, capable of producing metal objects and metal-containing objects. The additive manufacturing systems herein include extrusion printheads, microinductor printheads, and fusible build materials. The extrusion printheads produce relatively low-resolution layers of unfused build material, and the microinductor printheads fuse portions of these low-resolution layers to produce high-resolution layers of fused build material.

### BACKGROUND

Additive manufacturing systems, also referred to as “3D printers”, generate three-dimensional objects by the addition of material. This technology differs from “subtractive manufacturing”, wherein material is removed to produce a desired object. The use of an additive manufacturing system often includes a digital model of the desired object. This object is often divided into many thin layers via a software tool. Each layer of the object may then be successively produced by the additive manufacturing system until a physical approximation of the digital model is completed.

Additive manufacturing systems do not rely on the use of molds or costly components designed to produce a specific object. Due to this, these systems are often useful for the production of prototypes or art objects, where few copies of a desired object will be produced. Some desired objects may have a geometry that is not possible to produce through subtractive manufacturing.

Fused Deposition Modeling (FDM) is an additive manufacturing technology that has become very popular. Within an FDM system, a printhead heats a solid build material to a temperature near the melting point of the material, and the material is extruded onto a build plate or a previously extruded layer. As the heated material is extruded, it quickly cools and becomes a solid shortly after contacting the build plate or previous layer. These systems commonly employ a thermoplastic build material. Current FDM systems are limited in their printing speed. They are also limited in their ability to utilize support material.

### SUMMARY OF THE INVENTION

Briefly, and in non-limiting terms, described herein are additive manufacturing systems incorporating extrusion printheads, microinductor printheads, and fusible build materials. Methods of using these systems, and build materials useful for the additive manufacturing system embodiments herein, are also described. Herein, extrusion printheads produce relatively low-resolution layers of unfused build material, and microinductor printheads fuse portions of these low-resolution layers to produce relatively high-resolution layers or voxels of fused build material.

Embodiments described herein offer advantages relative to current additive manufacturing systems. Some embodiments herein are able to use a single build material to act as both a support material and as the material of the desired object. The unfused build material, which acted as a support material during printing may be reused as build material in future printing. Additionally, the use of fusible build material within the systems herein allows for the production of desired objects with high-resolution features, while also having high strength, toughness, and heat deflection.

Current additive manufacturing systems often require support structures or support material for the production of an object when portions of the desired object are not adequately supported in the z axis (vertically). Support structures often limit the feature resolution of desired objects and the surface finish achievable without post-processing steps (steps performed after printing is completed). In some embodiments described herein, the unfused build material acts as a support material that can be easily removed and thereby does not limit object resolution or surface finish. The use of a single build material for the desired object and the support material allows for an overall simpler additive manufacturing system and can decrease waste.

Current FDM systems must choose to prioritize printing speed or resolution, as an FDM system with a relatively small nozzle diameter will produce relatively high-resolution desired objects, at the cost of greater time needed for printing. Some embodiments described herein are able to utilize relatively low-resolution FDM-like nozzles that quickly extrude material, while still being able to produce high-resolution desired objects quickly due to a second, high-resolution microinductor printhead. In other words, some embodiments described herein can be thought of as first quickly extruding a low-resolution layer of unfused build material and second producing a high-resolution layer of fused build material by the action of a microinductor printhead.

### BRIEF DESCRIPTION OF THE DRAWINGS

FIG. 1 is a schematic diagram showing a front view of an embodiment of an additive manufacturing system.

FIG. 2 is a schematic diagram showing a side view of an embodiment of an additive manufacturing system.

FIG. 3 is a schematic diagram from a perspective view of an embodiment of an additive manufacturing system.

FIG. 4 illustrates a simplified process for the additive manufacture of a tree-shaped object, which could be performed by embodiments described herein.

### DETAILED DESCRIPTION OF THE INVENTION

The present disclosure provides systems and methods for additive manufacturing. The present disclosure also provides build materials that may be used with the systems and methods for additive manufacturing provided herein. Some build materials are inherently only useful within the systems and methods described herein. All references cited within this document are incorporated herein by reference in their entirety.

Embodiments, serving the purpose of examples, are described herein with sufficient detail to enable those of skill in the art to practice the invention. It should be understood that other embodiments may be realized and that various changes to the invention may be made without departing from the spirit and scope of the present invention. The detailed description of the embodiments of the present invention is not intended to limit the scope of the invention. The detailed description is presented to describe the features and characteristics of the present invention, to set forth the best mode of operation of the invention, and to sufficiently enable one skilled in the art to practice the invention. The scope of the present invention is to be defined only by the appended claims.

In the following description, for purposes of explanation, numerous specific details of certain embodiments are set forth. Reference in the specification to “an example”, “an embodiment”, or similar language means that a particular feature, structure, or characteristic described in connection with the example is included in at least that one embodiment, but not necessarily in other embodiments.

Within this specification, the singular forms “a,” “an,” and “the” include plural referents unless the context clearly dictates otherwise. Thus, for example, reference to “a polymer” includes one or more of such materials, and reference to “heating” includes reference to one or more of such steps.

As used herein, a plurality of items, structural elements, compositional elements, and/or materials may be presented in a common list for convenience. However, these lists should be construed as though each member of the list is individually identified as a separate and unique member. Thus, no individual member of such lists should be construed as a de facto equivalent of any other member of the same list solely based on their presentation in a common group without indications to the contrary.

As used herein, numerical values used in combination with “about” will be understood to describe all numerical values 10% above the numerical value to 10% below the value. For example, “a diameter of about 3 mm” will be understood to describe diameters of 2.7 to 3.3 mm, inclusive of all values within that range.

Concentrations, amounts, and other numerical data may be presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of 1 to 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than 4.5,” which should be interpreted to include all of the above-recited values and ranges. Additionally, such an interpretation should apply regardless of the breadth of the range or the characteristic being described.

### Definitions

As used herein, a “desired object” is a physical object that is produced by the action of an additive manufacturing system, and which is often based upon a digital object model. The desired object does not include any support material, although they may be physically linked at the time of printing. Support material is not intended to remain attached to the desired object. A desired object can be divided into smaller desired objects for easier production through the action of an additive manufacturing system. As used herein, a “rough object” includes a desired object along with any support material, unfused build material, and/or any other build material not part of the desired object that is physically attached to the desired object at the end of the printing process.

As used herein, “build material” refers to any material utilized within an additive manufacturing system that makes up at least a portion of the desired object or makes up at least a portion of support material.

As used herein, “fuse, fusing, fused, fusion” and other forms of this term are defined as melting, partial melting, sintering, fusing, increasing the number of metallic bonds, or otherwise joining together particles or atoms of at least one of the following: one or more metals, one or more metal alloys, one or more induction-conducive materials, and one or more materials capable of being heated through induction heating.

As used herein, “metallic” is an adjective that describes a material being made up of a metal or metal alloy. An “induction-conducive material” and variations of this term herein refer to a material that is capable of being heated through induction heating. An induction-conducive material may be at least partially made up of at least one of: a metallic material, a metal alloy, aluminum, an aluminum bronze, a brass, admiralty brass, chromium, copper, gold, Inconel, iron, a cast iron, lead, molybdenum, nickel, platinum, silver, a sterling silver, a steel, a carbon steel, a stainless steel, titanium, tungsten, zinc, tin, a babbitt, vanadium, beryllium, beryllium copper, bismuth, cadmium, cobalt, magnesium, manganese, a manganese bronze, mercury, palladium, rhodium, silicon, niobium, tantalum, carbon, sulfur, phosphorus, zirconium, rhenium, yttrium, hafnium, boron, a metal carbide, carbon fiber, graphite, and an alloy or composite of any of these materials.

A “fusible build material” and variations of this term herein refer to a material wherein particles or atoms within at least a portion of the material are capable of being fused. The fusion of a fusible build material may occur between particles of any size, any shape, and any composition, and any two particles undergoing fusion may be dissimilar in size, shape and/or composition. The fusion of a fusible build material may cause the resulting fused material to have different material properties. For example, after fusion, the fused material may have a higher or lower melting point than the unfused material.

A “printhead” may be defined herein as any component of an additive manufacturing system which interacts with or manipulates the build material for the purpose of producing a desired object or support material.

The terms “microinductor” and “induction heating element” are used interchangeably herein. The word or prefix “micro”, as used herein, indicates that the described element is preferred to be less than 1 millimeter in its largest dimension, but embodiments exist outside of this preferred range. However, whenever “micro” is used to discuss a printhead herein, the term does not describe a preferred size range of the printhead.

The term “particle” or variations of this term used herein may refer to pieces of a material that possess a low aspect ratio, or in other words, have exterior dimensions that are roughly equal in all directions. However, these terms may, in some embodiments, refer to materials that have a higher aspect ratio. For example, a metal powder intended for sintering usually contains particles with a low aspect ratio, which fall under the definition of particles herein. In another example, chopped carbon fibers possess a relatively high aspect ratio, but are useful in additive manufacturing and fall under the definition of particles herein.

As used herein, the term “printing” refers to any action performed by an additive manufacturing system that is performed in the course of producing a desired object. These actions may include: extrusion of build material, extrusion of support material, fusing of build material, fusing of build material, movement of build material, movement of motors to position printheads, producing a desired object, or melting of build material, and other actions.

As used herein, the terms “build plate” and “print bed” are synonymous, indicating the surface within the additive manufacturing system that supports layers of build material. As used herein, the “build volume” or “build environment” describes the total volume in which build material can be deposited in order to produce a desired object, including the deposition of any support material and/or waste material.

As used herein, a “polymer” and a “polymeric material” are synonymous. A polymer, a polymeric material, a “binder”, or a “binding material” referred to herein may be at least partially made up of at least one of: a polymeric material, an organic polymeric material, a thermoplastic, a biopolymer, polydimethylsiloxane, shellac, low-density polyethylene, high-density polyethylene, polypropylene, polymethylpentene, ethylene-vinyl acetate (EVA), polystyrene, polytetrafluoroethylene, polyvinyl chloride, polyvinyl alcohol (PVA), polychlorotrifluoroethylene, polylactic acid, an acrylic polymer, polymethyl methacrylate, polyether ether ketone (PEEK), a polyamide polymer, nylon 6, nylon 6-6, polybenzimidazole, a polycarbonate polymer, a polyether sulfone polymer, a polyoxymethylene (POM) polymer, a polyether ether ketone polymer, polyphenylene oxide, polyphenylene sulfide, polyvinylidene fluoride, a polyamide, a polycaprolactone, a polylactic acid, a poly(styrene-isoprene-styrene) (SIS), a poly(styrene-ethylene-butylene-styrene) (SEBS), a poly(styrene-butylene-styrene) (SBS), a high-impact polystyrene (HIPS), polystyrene, a thermoplastic polyurethane, a poly (acrylonitrile-butadiene-styrene) (ABS), a polymethylmethacrylate, a poly(vinylpyrrolidine-vinylacetate), a polyester (e.g., polyethylene terephthalate (PET), polyethylene naphthalate (PEN), polyethylene terephthalate glycol (PETG), and the like), a polycarbonate, a polyethersulfone, a polyether ether ketone, polyether aryl ketone, a polyetherimide, a polyethylene, a polyethylene oxide, a polyphenylene sulfide, a polypropylene, a polystyrene, a polyvinyl chloride, polyphenylene ethers (PPE), a poly(tetrafluoroethylene), a poly(vinylidene fluoride), a poly(vinylidene fluoride-hexafluoropropylene), a type of clay, a carbohydrate polymer, a polymer of one or more fatty acids, a natural wax, a cement, an inorganic material, a ceramic, a concrete, a cermet, a synthetic wax, paraffin wax, beeswax, soy wax, palm wax, gel wax, carnauba wax, shellac, a wax material similar to any in this list, a polymer known in research, a common commercial polymer, an engineering plastic, a copolymer of any polymer in this list, a metal or metal alloy, and a polymeric material similar to any within this list. In some embodiments, a binder surrounds particles and/or filaments of another material.

Used herein, the term “selective extrusion” refers to extruding build material in specific, non-random locations for the purpose of directly or indirectly producing a desired object. Used herein, the term “selective heating” refers to heating build material in specific, non-random locations for the purpose of directly or indirectly producing a desired object. Used herein, the term “selective fusing” refers to fusing build material in specific, non-random locations for the purpose of directly or indirectly producing a desired object.

In some embodiments, the present invention provides a system for additive manufacturing that includes at least two printheads, wherein at least one printhead performs at least the function of extruding build material, and at least one printhead is made up of at least one induction heating element. In embodiments of this type, a printhead that performs at least the function of extruding build material will be referred to herein as an “extrusion printhead” and a printhead that is made up of at least one induction heating element will be referred to herein as a “microinductor printhead”.

### Power and Control

In some embodiments, the additive manufacturing system is made up of at least: a power source, a computer system that directs the functions of the system, printheads that place and fuse the build material, a gantry and motor system that move the printheads, a structure that provides support for all system components, and a build material reservoir. The computer system may be internal or external to the additive manufacturing system. In some embodiments, the computer system is wirelessly attached to the additive manufacturing system through a technology such as WIFI, a Bluetooth connection, radio waves, infrared light signals, or another similar technology. In some embodiments, a touch screen and/or physical buttons are present on the additive manufacturing system itself to direct functions of the system.

In some embodiments, the additive manufacturing system can be connected to an external controller such as a personal computer, portable computer (for example a smartphone, tablet, or other similar device), or a specifically designed controller dedicated to operation of the printing system.

In some embodiments, there is provided a non-transitory computer-readable storage medium comprising a set of computer readable instructions stored thereon, which, when executed by a processor for an additive manufacturing system, cause the processor to carry out a number of instructions. In some embodiments, the instructions cause the processor to receive a digital object model. The digital object model defines the shape and nature of the three-dimensional object to be printed; in other words, the digital object model is made up of at least data defining an extent of an object in three-dimensions.

In some embodiments, software takes a digital object model and produces a plurality of layer definitions. Each layer definition may comprise a plurality of volumetric pixels, also referred to as voxels, which make up a layer of build material useful for constructing the desired object. Each layer definition may define extrusion voxel locations where build material must be deposited by the extrusion printhead, and it may define microinductor printhead voxel locations where build material is to be fused. Each layer definition may also comprise more complex print data, such as a fusing temperature profile for each voxel. In some embodiments, dissimilar fusing temperatures for individual voxels produce a difference in the elastic modulus of the resultant voxel of fused build material.

### Structure and Movement

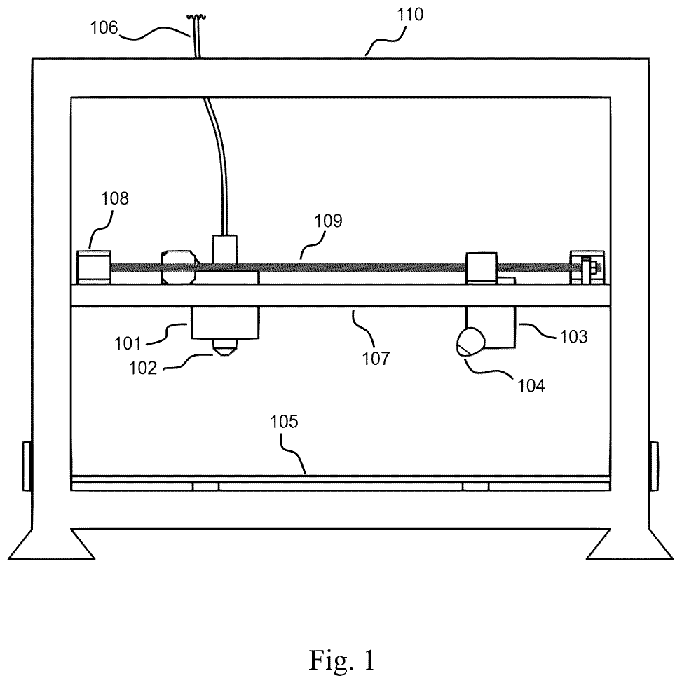

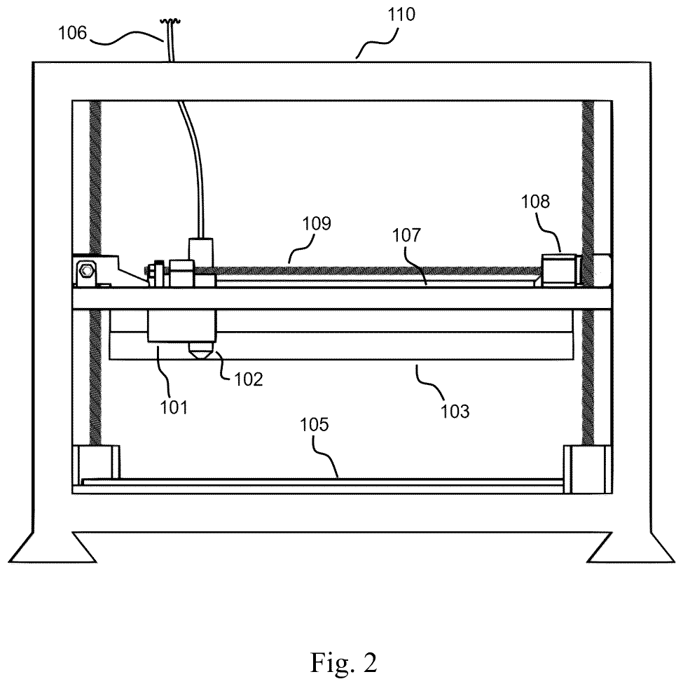

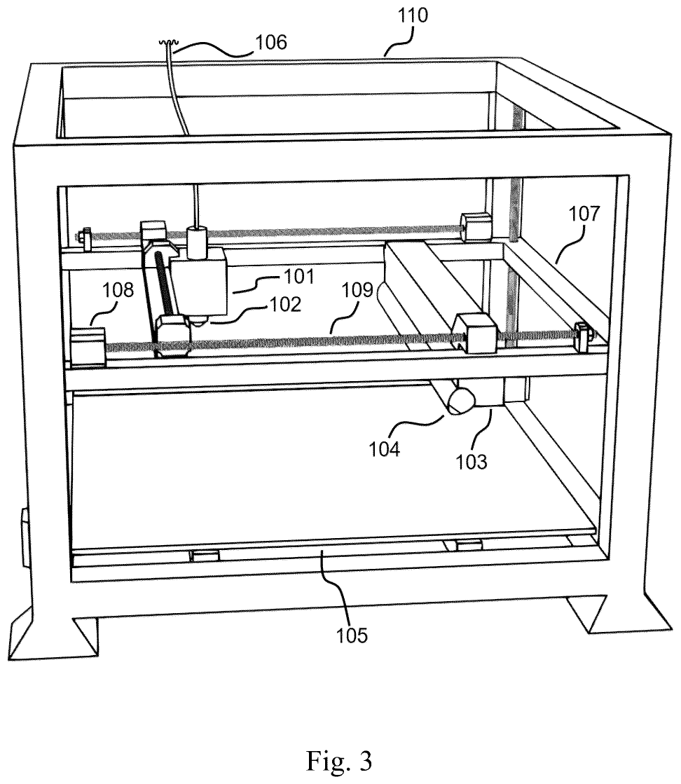

In the embodiments illustrated by FIGS. 1-3, a single extrusion printhead 101 and a single microinductor printhead 103 are present within an additive manufacturing system. In some embodiments, an open cube-like structure 110 supports the additive manufacturing system. In the embodiments illustrated by FIGS. 1-3, both printheads are supported by a gantry 107 that allows simultaneous movement of the printheads along the z axis. Lead screws, for example 109, and stepper motors, for example 108, are shown to be involved in the movement of parts of the additive manufacturing system. Two stepper motors, and their associated lead screws, are responsible for movement of the extrusion printhead in the x axis and the y axis. A single stepper motor and its associated lead screw are responsible for movement of the microinductor printhead. Two stepper motors, and their associated lead screws, are responsible for movement of the gantry that supports both printheads in the z axis. The extrusion printhead 101 takes in filamentous build material 106, heats the build material, and extrudes the build material through the extrusion nozzle 102. Extruded build material is deposited in a layer onto the print bed 105, or onto a previously extruded layer. As the microinductor printhead passes over an extruded layer, an induction heating array 104 selectively fuses portions and/or voxels within the layer.

In the embodiments illustrated by FIGS. 1-3, a microinductor printhead is capable of independent movement along the x axis. In these embodiments, an extrusion printhead is capable of independent movement along the x axis and the y axis, and a gantry supporting both printheads is moveable along the z-axis. The extrusion printhead is capable of being positioned along three axes in relation to the print bed, and the microinductor printhead is capable of being positioned along two axes in relation to the print bed. It is to be understood that the axes of motion, in the illustrated embodiments, serve as examples.

It is to be understood that movement along two axes describes any type of movement within a two-dimensional plane, and movement along three axes describes any type of movement within three-dimensional space.

In some embodiments, the relative positioning of an extrusion printhead, in relation to the print bed, is achieved by movement of the print bed along three axes and movement of the extrusion printhead along zero axes. In other embodiments the extrusion printhead is moved along one axis and the print bed is moved along two axes. In other embodiments, the extrusion printhead is moved along two axes and the print bed is moved along a single axis. In other embodiments, the extrusion printhead is moved along three axes and the print bed is moved along zero axes.

In some embodiments, the relative positioning of a microinductor printhead, in relation to the print bed, is achieved by movement of the print bed along two axes, and movement of the microinductor printhead along zero axes. In other embodiments, the microinductor printhead is moved along one axis, and the print bed is moved along one axis. In other embodiments, the microinductor printhead is moved along two axes, and the print bed is moved along zero axes. In some embodiments, the microinductor printhead performs multiple passes within the X-Y plane during fusing of a single layer.

In some embodiments, the relative positioning of a microinductor printhead, in relation to the print bed, is achieved by movement of the print bed along three axes and movement of the microinductor printhead along zero axes. In other embodiments the microinductor printhead is moved along one axis and the print bed is moved along two axes. In other embodiments, the microinductor printhead is moved along two axes and the print bed is moved along a single axis. In other embodiments, the microinductor printhead is moved along three axes and the print bed is moved along zero axes.

In some embodiments, the current position of at least one printhead or a print bed is determined by calculating the distance each of these components has moved from a known limit switch (also known as an endstop) location. In some embodiments, the current position of at least one printhead or a print bed is determined using a linear encoder, for example, a magnetic or optical linear encoder.

In some embodiments, movement of a gantry and/or individual printheads is preferably accomplished by high-resolution stepper motors. Various types of motors may be used for the movement of additive manufacturing system components in embodiments herein, including stepper motors, linear motors, servomotors, synchronous motors, D.C. motors, and fluid motors. In some embodiments, multiple types of motors are utilized within a single system to produce the desired motion. In some embodiments, stepper motor-driven screws are utilized to accomplish relative movement of printheads and/or a print bed. Some examples of the use of stepper motors within additive manufacturing systems are disclosed in U.S. Pat. No. 5,121,329, which is incorporated herein by reference, in its entirety.

In some embodiments, a layer of material is present on top of the print bed for the purpose of increasing adhesion between a build material and the print bed. In some embodiments, this layer is chemically adhesive. In some embodiments, the layer has a high roughness and may be a type of sandpaper.

In some embodiments, layers of extruded build material are of uniform thickness. In some embodiments, layers of extruded build material vary in height, as desired for a particular desired object. Varying layer height may be useful to increase the z-axis resolution of a particular portion of a desired object.

In some embodiments, the printheads are capable of entirely independent movement without the use of a shared gantry system. Other systems of moving the printheads can also be used, such as those used in delta 3D printers, polar 3D printers, robotic arm-type 3D printers, and others. In some embodiments, more than one of each type of printhead can be used to increase printing speed, increase the build volume, or allow for the extrusion and/or fusing of a larger number of materials.

In some embodiments, the print bed is capable of being precisely heated. In some embodiments, the print bed is capable of being heated by ceramic heating elements. In some embodiments, the print bed is capable of being heated using a closed-loop heating system. In some embodiments, an enclosure surrounds an additive manufacturing system. In some embodiments, the interior of an enclosure is capable of being heated to a desired temperature or temperature range. In some embodiments, a heating element is present within an additive manufacturing system for the purpose of heating the interior of an enclosure (this could alternatively be referred to as a chamber heater).

In some embodiments, an additive manufacturing system is made up of one or more microinductor printheads present within a currently known type of additive manufacturing system. The one or more microinductor printheads may be present in that type of system in addition to the standard printheads therein or in place of the standard printheads therein, but the remaining portions of the system would generally remain the same. In some embodiments, one or more microinductor printheads could replace the electron beam in a powder bed fusion system and/or an electron beam melting (EBM) system. In some embodiments, one or more microinductor printheads could replace the laser in a powder bed fusion system, a direct metal laser sintering (DMLS) system, an electron beam melting (EBM) system, a selective heat sintering (SHS) system, a selective laser melting (SLM) system, and/or a selective laser sintering (SLS) system.

### General Printing Process

In some embodiments, the process for the production of a desired object is as follows in this paragraph. A first layer of unfused build material is selectively extruded onto the build plate. This is done by an extrusion nozzle passing over each area that requires build material and selectively extruding build material in those areas. The microinductor printhead passes over all portions of this unfused build material that require fusing. The individual heating elements within the microinductor array are used to selectively fuse portions of the build material. In some embodiments, this fusing process may be performed on portions of a particular layer while the extrusion printhead is still extruding build material within the same layer. In some embodiments, the microinductor printhead moves continuously over the build material. In some embodiments, the microinductor printhead: moves to a portion of the build material requiring fusing, stops moving while fusing of the build material occurs, and begins moving again after the required fusing has concluded. The first layer may take any shape dictated by a computer system. The second layer, and each subsequent layer, may take different shapes, as required by the cross section of each layer of the digital object model, including any desired support material. For the process wherein each layer is formed only in a horizontal plane consisting of the x axis and the y axis, at least one motor is selectively actuated after each layer is produced to raise the printheads along the z axis by a height necessary for the extrusion and possible fusing of the following layer.

In some embodiments, non-planar printing is utilized. During non-planar printing, at least a single layer is formed wherein the extruded and/or fused build material does not lie within a single plane. In some embodiments, non-planar printing is utilized wherein at least one printhead moves in 3 dimensions relative to the print bed during the extrusion and/or fusing of a single layer. In some embodiments, non-planar printing is utilized wherein it is not possible to distinguish where one layer ends and another begins, as at least one printhead is always or nearly always moving in 3 dimensions relative to the print bed. An example of this type of printing is FDM helical printing (sometimes referred to as “vase mode”).

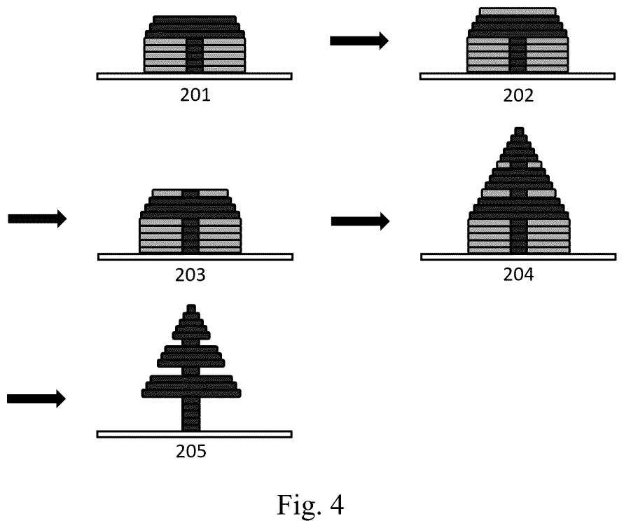

FIG. 4 illustrates the state of build material during printing within some additive manufacturing system embodiments described herein. The printing process begins with the selective deposition of unfused material 202 onto the print bed, or onto previously deposited layers of build material 201. The deposition is performed by an extrusion printhead. Selective fusing of the unfused build material is then performed within the most recently deposited layer, if fused build material is desired in that particular layer. An entire extruded layer of build material may be fused, a portion of an extruded layer may be fused 203, or none of an extruded layer may be fused. This process is repeated until the entire desired object has been formed 204. Removal of unfused build material may be performed to produce a desired object free of unfused build material 205.

### Extrusion Printhead

In some embodiments, an additive manufacturing system is made up of at least an “extrusion printhead” that functions to extrude build material. The extrusion printhead is made up of at least at least one extrusion nozzle. In some embodiments, the extrusion printhead includes a volume for the purpose of heating build material. In some embodiments, the extrusion printhead includes metallic fins for the purpose of cooling a portion of the extrusion printhead. In some embodiments, the extrusion printhead includes at least one cooling fan for the purpose of cooling a portion of the extrusion printhead and/or for the purpose of cooling recently extruded build material. In some embodiments, the functions of an extrusion printhead are equivalent or similar to the functions of the printhead in a Fused Deposition Modeling (FDM) additive manufacturing system. The structure, function, and control of FMD printheads are described in US Pat. No. 5,121,329 to Crump, the entirety of which is incorporated herein by reference, and other documents and materials. In some embodiments, at least one extrusion printhead deposits build material selectively (this is preferred). In some embodiments, at least one extrusion printhead deposits build material non-selectively (this is not preferred). In some embodiments, the extrusion printhead is a continuous inkjet (CIJ) printhead, a drop-on-demand printhead, and/or a piezo drop-on-demand (DOD) printhead.

In some embodiments, build material extrusion processes comprise heating a build material and extruding the build material through an extrusion nozzle. In some embodiments, build material is heated until it reaches a non-solid state before extrusion. A non-solid state may be a liquid state, a rubbery state, a state of viscous flow, or other similar states not defined as solid. In some embodiments, the build material is heated to a temperature equal to or greater than its glass transition temperature before extrusion through an extrusion nozzle. In some embodiments, the build material is heated to a temperature equal to or greater than its melting temperature before extrusion through an extrusion nozzle. In some embodiments, the build material is heated to a temperature wherein the build material appreciably decreases in viscosity before extrusion through an extrusion nozzle. In some embodiments, extruded build material cools to a temperature below its glass transition temperature before it is fused by the action of a microinductor printhead. In some embodiments, extruded build material cools to a solid state before it is fused by the action of a microinductor printhead. In some embodiments, extruded build material cools to a glassy state before it is fused by the action of a microinductor printhead.

In some embodiments, the maximum temperature reached by the build material before extrusion is controlled by a computer system and a heating element on or near an extrusion printhead. It should be understood that build material has been “extruded” when it has passed through an extrusion nozzle.

In some embodiments, a ceramic heating element is utilized to heat a build material before extrusion through an extrusion printhead. In some embodiments, a temperature sensor such as a thermistor or a thermocouple is present near a ceramic heating element as part of a closed-loop system for heating a build material. In some embodiments, a resistive heating element is utilized to heat build material before extrusion through an extrusion printhead. In some embodiments, a temperature sensor such as a thermistor or a thermocouple is present near a resistive heating element as part of a closed-loop system for heating the build material. In some embodiments, a temperature sensor such as a thermistor or a thermocouple is present close to a volume wherein build material is heated so that the temperature sensor can determine or approximate the temperature of the heated build material.

In some embodiments, a build material is heated at a temperature of 30-1500° C., 160-250° C., 180-200° C., 200-240° C., 500-1500° C., 650-1100° C., 30-160° C., or 45-85° C. before extrusion. In some embodiments, a build material is extruded at a temperature of 30-1500° C., 160-250° C., 180-200°° C., 200-240° C., 500-1500° C., 650-1100° C., 30-160° C., or 45-85° C. In some embodiments, a build material comprising a polymeric material is heated at a temperature of 160-250° C., 180-200°° C., or 200-240° C. before extrusion. In some embodiments, a build material comprising a metallic material is heated at a temperature of 500-1500° C. or 650-1100° C. before extrusion. In some embodiments, a build material comprising a wax material is heated at a temperature of 30-160° C. or 45-85° C. before extrusion.

In some embodiments, a build material is extruded through an extrusion nozzle at a temperature lower than the temperature required to instantaneously fuse a build material. In some embodiments, the difference between the extrusion temperature of a build material and the fusing temperature of the same build material is 5-20° C., 20-50° C., 50-100° C., 100-250° C., or 250-3500° C.

In some embodiments, the build material is preferably heated within the extrusion printhead. In other embodiments, the build material is heated near the extrusion printhead, and the build material is transferred to the extrusion printhead while in a non-solid state.

In some embodiments, a build material is provided in the form of a filament. In some embodiments, a reservoir of filamentous build material is present as a spool of filament. In some embodiments, a build material is present as powder, beads, particles, turnings, spheres, granules, or other low-aspect-ratio pieces of a material. In some embodiments, a reservoir of a low-aspect-ratio build material is present as a hopper containing the material.

In some embodiments, extruded material may be unintentionally extruded in such a way that build material is present above the intended maximum height of the current layer. In some embodiments, an extrusion nozzle may advantageously function to remove material unintentionally above the intended maximum height of the current layer. In some embodiments, as an extrusion nozzle moves over a specific layer it removes material above the intended maximum height of the current layer. In some embodiments, a blade, a heated blade, or another object is present for the purpose of removing material above the intended maximum height of the current layer. In some embodiments, a thermal camera is present to monitor the heating of the build material in a closed-loop or open-loop manner.

In some embodiments, the build material is non-selectively deposited within the build volume and at least some build material is selectively fused. In some embodiments, a sprayer nozzle may be used for the purpose of depositing build material selectively or non-selectively into the build volume. In some embodiments, a drop-on-demand system may be used to deposit build material into the build volume selectively or non-selectively. In some embodiments, build material is extruded and non-selectively formed into a layer by the movement of a squeegee, doctor blade, or similar object. In some embodiments, a technology currently known to be utilized for the deposition of build material, within a currently known material jetting or binder jetting 3D printer, is present and performs selective or non-selective deposition of build material within the build volume. In some embodiments, a layer of particles is deposited as a method of non-selective deposition, as is used in known powder-bed fusion additive manufacturing systems.

### Build Material Movement

In some embodiments, a filamentous form of build material is utilized, and drive rollers are present for the purposes of forcing the filament into the extrusion printhead and forcing heated build material out of the extrusion nozzle. In some embodiments, these rollers are present within the extrusion printhead. In some embodiments, these rollers are present outside the extrusion printhead. In some embodiments, each roller is driven directly by a motor. In some embodiments, the movement of a plurality of rollers is linked by gears, a belt drive, or a chain drive. In some embodiments, rotational power is supplied to the drive rollers by a motor and gears, a belt drive, or a chain drive. These motors may be selected from any suitable type of motor, such as stepper motors, linear motors, servomotors, synchronous motors, D.C. motors, and fluid motors. In some embodiments, a high-resolution stepper motor is utilized for the purpose of delivering power to the drive rollers. In some embodiments, idler rollers are present on the opposite side of a filament relative to drive rollers. These idler rollers assist in gripping the filamentous build material.

In some embodiments, the rollers or gears that apply force to a filamentous build material are located close to or directly connected to an extrusion nozzle. This is often referred to as a “direct drive extruder”. In some embodiments, the rollers or gears that apply force to a filamentous build material are located far from the nozzle. This is often referred to as a Bowden extruder. In this type of extrusion printhead, a tube guides a filamentous build material from the rollers or gears into the nozzle. The tube is often referred to as a Bowden tube.

In some embodiments, a hopper containing low-aspect-ratio build material is connected to a volume for heating the build material to a non-solid state, and pressure is generated by at least one pump, at least one screw, or other means to extrude the heated build material through the extrusion nozzle. In some embodiments, a build material is heated far from an extrusion printhead, and heated non-solid build material is forced to move into and through the extrusion printhead. In some embodiments, the build material is heated far from the extrusion printhead, and heated liquid build material is forced to move into the extrusion printhead. In some embodiments, a non-solid or liquid build material is heated far from an extrusion printhead and is moved into the extrusion printhead by means of a fixed or variable displacement pump. In some embodiments, a single-screw extrusion printhead is present. In some embodiments, a dual-screw extrusion printhead is present. In some embodiments, a build material exists in a non-solid state at the ambient temperature surrounding the additive manufacturing system, and non-solid build material is forced to move into and through the extrusion printhead via methods described in this paragraph.

### Addition of Colorant

In some embodiments, a colorant-addition volume is present wherein colorant is added to a build material before it is extruded. In some embodiments, a colorant-addition volume is present wherein colorant is added to a build material after the build material has been heated and before it exits an extrusion nozzle. In some embodiments, a colorant-addition volume is present with a geometry intended to cause mixing (e.g. turbulent flow) of a colorant with a build material as heated build material is forced through the colorant-addition volume. The addition of colorants within the context of some types of extrusion nozzles is described in US Pat. No. 9,283,714, which is incorporated herein by reference, in its entirety.

In some embodiments, an additive manufacturing system is made up of at least an extrusion printhead, a microinductor printhead, and a colorant printhead, wherein the colorant printhead is capable of selectively adding at least one of a dye, a pigment, and a colorant to at least a portion of a layer of build material some time before a subsequent layer of build material is added. In some embodiments, the colorant printhead is a continuous inkjet (CIJ) printhead, a drop-on-demand printhead, and/or a piezo drop-on-demand (DOD) printhead.

### Extrusion Nozzle Size

In some embodiments, the internal diameter of an extrusion nozzle, at the point where build material exits the extrusion nozzle, is 0.05 mm to 100 mm, 0.10 mm to 1.40 mm, 0.20 mm to 0.40 mm, 0.40 mm to 0.80 mm, 0.80 mm to 1.00 mm, or greater than 1.00 mm. In some embodiments, the internal diameter of an extrusion nozzle, at the point where build material exits the extrusion nozzle, is about 0.20 mm, about 0.30 mm, about 0.35 mm, or about 0.40 mm. In some embodiments, the internal diameter of an extrusion nozzle, at the point where build material exits the extrusion nozzle, is 0.20 mm, 0.30 mm, 0.35 mm, 0.40 mm, 0.60 mm, 0.80 mm, 1.00 mm, or 1.20 mm. In some embodiments, the size of the extrusion nozzle, at the point where build material exits the extrusion nozzle, is larger than the center-to-center distance (pitch) of induction heating elements of a microinductor printhead. In some embodiments, an array of extrusion nozzles is present.

### Microinductor Printhead

A microinductor printhead is made up of at least a single induction heating element. An induction heating element is made up of an inductor that can be selectively powered, and the induction heating element is capable of causing induction heating in a material. An inductor is often alternatively referred to as a coil. In some embodiments, the inductor of at least one induction heating element is in the shape of a pancake coil shape or a similar shape. The inductor within an inductive heating element, in embodiments herein, may be in any shape, design, and size currently known or may be in any shape, design, or size which would be currently understood to be useful.

In some embodiments, a plurality of induction heating elements is present. A plurality of induction heating elements is also referred to herein as a “microinductor array”. In some embodiments, the microinductor printhead additionally includes a physical linkage between the induction heating elements and other portions of the structure of an additive manufacturing system. In some embodiments, an additive manufacturing system is made up of at least an extrusion printhead and a microinductor printhead. In some embodiments, a microinductor printhead includes a physical linkage between the heating elements and a gantry, wherein the gantry supports both the microinductor printhead and an extrusion printhead. In some embodiments, a microinductor printhead additionally includes a mechanism to position the heating elements parallel to the plane of the print bed. In some embodiments, a microinductor printhead includes a mechanism to position the microinductor array along the z axis (normal to the print bed) relative to an extrusion printhead. In some embodiments, the microinductor printhead and the extrusion printhead are physically linked, and they are not capable of independent movement within the system. In some embodiments, the microinductor printhead and the extrusion printhead are positioned such that the extrusion nozzle is surrounded by a 2-dimensional microinductor array. In some embodiments, at least one cooling fan and/or at least one thermally conductive component is/are present within an additive manufacturing system are present to cool build material.

Techniques and methods of producing microinductors having micrometer scale features are taught at least by Hofmann (Hofmann, C.; Satwara, M.; Kroll, M.; Panhale, S.; Rochala, P.; Wiemer, M.; Hiller, K.; Kuhn, H. Localized Induction Heating of Cu-Sn Layers for Rapid Solid-Liquid Interdiffusion Bonding Based on Miniaturized Coils. Micromachines 2022, 13, 1307.), incorporated herein by reference, in its entirety.

In some embodiments, at least one microinductor printhead is preset within an additive manufacturing system. In some embodiments, each induction heating element of a microinductor printhead is individually addressable. In some embodiments, a single microinductor printhead and a single extrusion printhead are present within an additive manufacturing system. In some embodiments, a single extrusion printhead and multiple microinductor printheads are present in an additive manufacturing system. In other embodiments, a single microinductor printhead and multiple extrusion printheads are present in an additive manufacturing system. In some embodiments, multiple microinductor printheads and multiple extrusion printheads are present in an additive manufacturing system. In some embodiments, multiple extrusion printheads are present within an additive manufacturing system for the purpose of having each extrusion printhead primarily responsible for the extrusion of a single build material, dissimilar from the build materials that the other extrusion printheads are responsible for.

In some embodiments, the operating frequency of at least one microinductor is 3 kHz to 1.2 MHZ, 3 kHz to 30 kHz, 30 kHz to 400 MHZ, or 100 kHz to 200 kHz. In some embodiments, the maximum power output of all microinductor printheads present in the system is 50 W to 5 MW, 50 W to 5 kW, 10 kW to 30 kW, or 50 kW to 450 kW.

In some embodiments, induction heating elements within a microinductor printhead are arranged in a 1-dimensional array (in other words, in a line or in a linear array). In some embodiments, multiple induction heating elements within a microinductor printhead are arranged in a 2-dimensional array (in other words, arranged within a plane). In some embodiments, resistive induction heating elements within a microinductor printhead are arranged in a non-standard arrangement that is not a 1-dimensional array or a 2-dimensional array. For example, a specific non-standard array arrangement appears linear when viewed from the top and bottom but appears curved when viewed from the side.

In some embodiments, the feature size of fused build material within a desired object and/or support material, produced by the action of a microinductor printhead, is smaller than or equal to the center-to-center distance (pitch) of induction heating elements of the microinductor printhead. In some embodiments, the feature size of fused build material, produced by the action of a microinductor printhead, is not equal in both axes of a layer of build material. In some embodiments, the feature size of fused build material is dictated along a first axis by the pitch of induction heating elements within a microinductor printhead, and is dictated along a second axis by the speed at which the microinductor printhead moves over the build material.

In some embodiments, a 1-dimensional array of induction heating elements, within a microinductor printhead, is made up of at least: 20-29,000; 100-15,000; 350-7,500; 1,000-2,000; 2,000-3,000; 3,000-4,000; 4,000-6,000; or about 1,920 induction heating elements. In some embodiments, a 2-dimensional array of induction heating elements, within a microinductor printhead, is made up of at least: 10,000-33,200,000; 100,000-200,000:200,000-500,000:500, 000-1,100,000:1,100,000-2,100,000:2,100,000-8,300,000; 8,300,000-33,200,000; or 33,200,000-133,000,000 induction heating elements.

In some embodiments, each individual induction heating element of a microinductor printhead has an area equivalent to a circle with a diameter of 0.001-2 mm, 0.001-0.005 mm, 0.005-0.010 mm, 0.010-0.050 mm, 0.050-0.100 mm, 0.100-0.200 mm, 0.200-0.300 mm, 0.300-0.400 mm, or greater than 0.400 mm.

In some embodiments, induction heating elements of a microinductor printhead are fabricated using at least microelectromechanical systems (MEMS) fabrication techniques. In some embodiments, induction heating elements of a microinductor printhead are fabricated using at least lithographic fabrication techniques. In some embodiments, induction heating elements of a microinductor printhead are fabricated using at least semiconductor lithography fabrication techniques. In some embodiments, induction heating elements of a microinductor printhead are built on a substrate. This substrate may be glass, silicon, sapphire, langasite, or alumina. Glass may be beneficial due to its low thermal conductivity. Silicon may also be used despite its high thermal conductivity due to its ease of processing with MEMS fabrication. Silicon underneath a microinductor array can be etched away to leave the microinductor on a thin membrane of dielectric material to increase power efficiency. The process of fabricating a microinductor array using MEMS techniques is to grow a dielectric layer, then use photolithography to pattern the substrate, and then deposit the microinductor material and conductive leads using sputtering or e-beam evaporation.

In some embodiments, a microinductor printhead is capable of positioning the induction heating element surfaces a distance from the build material that is intended to be fused. This distance will be referred to as the microinductor printhead “vertical offset”. In some embodiments, the vertical offset is 0 mm, and the induction heating element surfaces will contact the build material to be fused. In some embodiments, the vertical offset is 1-10 μm, 10-50 μm, 50-100 μm, 100-300 μm, or greater than 300 μm. In some embodiments, a microinductor printhead includes a mechanism to adjust the vertical offset. In some embodiments, a microinductor printhead includes a mechanism to adjust the vertical offset manually. In some embodiments, a microinductor printhead includes a mechanism to adjust the vertical offset using a computer-controlled motor.

In some embodiments, the following fusing steps are performed: a microinductor printhead is positioned over extruded build material, individual induction heating elements positioned proximal to voxels of build material that need to be fused are powered, and the individual induction heating elements are powered for a desired length of time. In some embodiments, the following fusing steps are performed: a microinductor printhead is positioned over extruded build material and individual induction heating elements positioned proximal to voxels of build material that need to be fused are powered. In some embodiments, the following fusing steps are performed: the microinductor printhead is constantly moving along one axis over extruded build material, individual induction heating elements proximal to voxels of build material that need to be fused are powered, and the individual induction heating elements are powered for a desired length of time. In some embodiments, the following fusing steps are performed: the microinductor printhead is constantly moving along one axis over extruded build material and individual induction heating elements proximal to voxels of build material that need to be fused are powered.

In some embodiments, an individual induction heating element of the microinductor printhead is capable of reaching the desired output power needed for build material fusing within 0-2000 ms, 0-1 ms, 1-5 ms, 5-10 ms, 10-20 ms, 20-50 ms, or 50-300 ms, or greater than 300 ms.

### Build Materials

Additive manufacturing system embodiments described herein may use multiple materials for the purpose of producing desired objects. In some embodiments, build materials useful herein are able to be fused at a temperature equal to or greater than the temperature at which they are extruded by an extrusion printhead. In some embodiments, a single type of build material is utilized. In other embodiments, multiple types of build materials are utilized. In some embodiments, at least one build material is used for the production of support material and at least one build material is used for production of the desired object.

In some embodiments, the fusing temperature of a fusible build material is greater than the extrusion temperature of the same material. In some embodiments, the fusing temperature of a fusible build material is greater than the extrusion temperature of the same material by at least: 10° C., 25° C., 60° C., 90° C., 120° C., 150° C., 300° C., 500° C., 1000° C., or 2000° C. In some embodiments, the fusible build material is at least partially made up of an interpenetrating network before, during, and/or after fusing.

In some embodiments, a fusible build material is capable of acting as support material in its unfused state. In some embodiments, multiple build materials are used. In some embodiments, multiple build materials are used, wherein at least one build material is primarily useful to provide fused or unfused support material to the desired object. In some embodiments, support structures attached to a desired object after printing are partially or wholly made up of unfused build material. In some embodiments, unfused build material is only present between a fused portion of a support structure and a fused portion of a desired object. U.S. Pat. No. 5,503,785, patented Apr. 2, 1996, to Crump et al. is incorporated herein in its entirety.

In some embodiments, a fusible build material is still capable of additional fusing after printing is completed, or is in other words, partially fused when printing is completed. In some embodiments, a fusible build material is further fused after printing is completed. In some embodiments, a fusible build material is further fused after printing is completed, involving the use of an oven.

In some embodiments, a fusible build material is made up of particles or filaments of a fusible build material within a binder material. In some embodiments, the particles or filament within a binder material are fusible, whereas the binder material is not fusible. In some embodiments, the fusible build material has a higher melting temperature than the binder material. In some embodiments, the melting point of at least a portion of the particles or filaments within a binder material is 0-3500° C., 200-300° C., 500-800° C., 700-1000° C., 1000-2000° C., 2000-3500° C., or greater than 3500° C. In some embodiments, the melting point of at least a portion of the particles or filaments within a binder material is 0-3500° C., 200-300° C., 500-800° C., 700-1000° C., 1000-2000°° C., 2000-3500° C., or greater than 3500° C. different than the melting point of the binder material.

A build material may be present in any of the following forms: a filamentous form that may be stored on a spool, a granulated form (powder, beads, particles, turnings, spheres, granules, or other low-aspect-ratio pieces of a material) that may be stored in a hopper, a core-sheath filamentous form that may be stored on a spool, or a coated core particle form that may be stored in a hopper. The core and sheath of a core-sheath build material may each contain any number of induction-conducive materials and any number of binder materials, as long as the core and sheath are dissimilar in their makeup. A coated core particle build material may have any number of coating layers around a core, and each coating layer and the core may each contain any number of induction-conducive materials and any number of binder materials, as long as the materials on either side of each core-coating or coating-coating interface are dissimilar in their makeup. In some embodiments, an additive manufacturing system may utilize multiple forms of build material.

In some embodiments, a fusible build material is at least partially made up of an induction-conducive material. In some embodiments, a fusible build material is at least partially made up of at least one binder material and particles of at least one induction-conducive material. In some embodiments, a fusible build material is at least partially made up of one or more binder materials and particles of an induction-conducive material, wherein one or more binder materials may be present in the form of particles. In some embodiments, a fusible build material is at least partially made up of: a binder material and particles at least partially made up of an induction-conducive material, wherein the particles may additionally be made up of a binder material. In some embodiments, a fusible build material is made up of at least one or more polymeric binder materials and particles of an induction-conducive material. In some embodiments, a fusible build material is at least partially made up of one or more binder materials and particles of at least one of the following materials: a metallic material, a metal alloy, a metal carbide, copper, a brass, aluminum, an iron, a steel, stainless steel, tungsten, chromium, nickel, cobalt, carbon fiber, graphite, silicon, platinum, silver, gold, or an alloy of any of these metals.

In some embodiments, wherein a build material utilizes induction-conducive material and binder material, the mass of the induction-conducive material makes up 1-99% of the total mass of the build material. In some embodiments, wherein a build material utilizes induction-conducive material and binder material, the mass of the induction-conducive material makes up 1-60%, 60-99%, 70-95%, 10-40%, or 20-35% of the total mass of the build material. Examples of a metallic particle and binder composite materials are currently offered for sale, and one is described in the product description of Filamet™ (The Virtual Foundry “How To 3d Print Metal” Accessed Nov. 17, 2022, incorporated by reference herein, in its entirety).

In some embodiments, a build material is at least partially made up of a clay and/or a ceramic. In some embodiments, a build material is at least partially made up of a clay and/or a ceramic and an induction-conducive material. In some embodiments, a build material is at least partially made up of: a clay and/or a ceramic particles, an induction-conducive material, and at least one binder material. In some embodiments, a build material is a type of ceramic and/or clay containing particles of induction-conducive material, and a hopper is used to store the ceramic and/or clay before extrusion. In any of the embodiments herein, a clay and/or ceramic may contains additives, such as colorants and/or lubricants. In some embodiments, a build material is a composite of an inorganic material and a binding material, wherein particles capable of being heated by induction heating are present. In some embodiments, a build material is a composite of a binder and particles of a clay and/or ceramic, wherein particles capable of being heated by induction heating are present. In some embodiments, a build material is a composite of a binder and particles of a clay and/or ceramic, wherein particles capable of being heated by induction heating are present, formed into a filament. In some embodiments, a clay and/or ceramic and binder composite material is a filament and is made up of at least a clay and/or ceramic particle core, wherein particles capable of being heated by induction heating are present, surrounded by a sheath of binding material. In some embodiments, a clay and/or ceramic and binder composite material is a filament, wherein particles of a clay and/or ceramic material containing particles capable of being inductively heated are surrounded by binding material. In some embodiments, a clay and/or ceramic and binder composite material is a filament, wherein binding material is surrounded by particles of a clay and/or ceramic material, wherein particles capable of being heated by induction heating are present.

In some embodiments of a clay and/or ceramic and binder composite material, the mass of the clay and/or ceramic makes up 1-99%, 10-80%, 20-60%, or less than 50% of the total mass of the composite material. Examples of clay and/or ceramic material and binder composite materials are currently offered for sale. One of these commercially available materials is described in the product description of LAYCERAMIC (Kai Parthy, CC-Products, “LAYCERAMIC sinter-able filament for printing”, June 2017). This product description is incorporated by reference herein, in its entirety.

In some embodiments, a build material is at least partially made up of: particles of a first metallic material and a second metallic material. In some embodiments, a build material is at least partially made up of: particles of a first metallic material and a second metallic material, wherein the melting point of the second metallic material is higher than the melting point of the first metallic material. In some embodiments, a build material is at least partially made up of: particles of a first metallic material and a second metallic material, wherein the melting point of these materials is sufficiently separated such that the second metallic material can be a liquid, or non-solid, while the first metallic material remains a solid within the same build material. In some embodiments, a build material is at least partially made up of particles of zinc or a zinc alloy, along with tin or a tin alloy.

In some embodiments, a fusible build material is at least partially made up of (filled) with a non-build material. In some embodiments, a build material may be filled with glass particles and/or fibers. In some embodiments, a build material may be filled with carbon fibers. In some embodiments, a build material may be filled with fibers and/or particles of an inorganic material. In some embodiments, a build material may be filled with fibers and/or particles of a ceramic material. In some embodiments, a build material is food safe, biocompatible, and/or capable of use in cell culture.

In some embodiments, particles within a build material may be 0.5 nm to 100 nm, 1 nm to 3 mm, 50 nm to 100 μm, 15 μm to 85 um, or 30 μm to 65 μm in average diameter. In some embodiments, a build material that is not a fusible build material may be utilized by an additive manufacturing system in addition to a fusible build material. In some embodiments, a non-fusible build material may be utilized by a system herein to provide support material to the desired object.

In some embodiments, one or more compounds or materials known to be useful within a flux material are present within a build material. In some embodiments, one or more chemical reducing agents are present within a build material. In some embodiments, one or more of the following materials are present within a build material to act as a flux: zinc chloride, a mixture of zinc chloride and an inorganic halide, a mixture of zinc chloride and an inorganic acid, a molten salt, phosphoric acid, a derivative of phosphoric acid, an organic halide, hydrazine, pine resin, an organic acid, an amino acid, an amine, and the combination of an amine and a halogen.

In some embodiments, an additive manufacturing system incorporates a multi-material system, wherein the multi-material system is capable of altering a build material being extruded during printing, without the interaction of a human user. In some embodiments, a multi-material system operates by switching from extrusion of a first build material to extrusion of a second build material, with additional switches being possible. In some embodiments, a multi-material system operates by adjusting the ratio of two or more build materials that are being extruded simultaneously.

In some embodiments, an additive manufacturing system herein is capable of being used in a sub-optimal manner by using a non-fusible material and intentionally not using any microinductor printheads that are present, so that the system operates in a manner similar to an FDM additive manufacturing system.

In some embodiments, an additive manufacturing system herein is capable of being used in a sub-optimal manner wherein non-selective fusion is performed along with selective extrusion of build material. In these embodiments, the extrusion nozzle or nozzles are entirely responsible for the feature size of the objects produced.

### Gases for use Within the Build Volume

In some embodiments, at least a portion of the build volume contains a gas or mixture of gases that is less flammable than air. In some embodiments, at least a portion of the build volume contains a gas or mixture of gases that is less chemically reactive than air. In some embodiments, at least a portion of the build volume contains at least one inert gas and/or noble gas at a concentration higher than is present in air. In some embodiments, at least a portion of the build volume contains nitrogen at a higher concentration than is present in air. In some embodiments, at least a portion of the build volume contains oxygen in a lower concentration than is present in air. In some embodiments, at least a portion of the build volume contains 1-10% oxygen. In some embodiments, at least a portion of the build volume contains one or more of the following gases at a higher concentration than is present in air: neon, argon, helium, and carbon dioxide. In some embodiments, a gas or mixture of gases known to be useful for welding applications, as a shielding gas or an active gas, has been added to at least a portion of the build volume.

### Processing After Printing

In some embodiments, after the printheads have completed their actions for the production of a desired object or a rough object, additional processing steps are performed. These additional processing steps may be performed while the desired object is still, in some manner, tethered to the print bed or after it has been removed from the print bed. In some embodiments, processing after printing serves to remove unfused build material from the fused build material. In some embodiments, processing after printing serves to remove unfused build material by mechanical agitation, such as scrapping, brushing, or sandblasting away the unfused build material. A solvent described within this paragraph may be a single solvent or a solution of multiple solvents selected from the following list: water, acetic acid, acetone, acetonitrile, benzene, butanol, butyl acetate, carbon tetrachloride, chloroform, cyclohexane, dichloroethane, dichloromethane, dimethylformamide, dimethyl sulfoxide, dioxane, ethanol, ethyl acetate, diethyl ether, heptane, hexane, methanol, methyl ethyl ketone, pentane, propanol, diisopropyl ether, tetrahydrofuran, toluene, xylenes, pyridine, piperidine, n-methylpyrrolidone, and/or another similar solvent. In some embodiments, processing after printing includes removing unfused build material by at least partially dissolving or solubilizing the unfused build material using a solvent. In some embodiments, unfused build material is dissolved or solubilized using a solvent that is at a temperature of greater than 22° C. In some embodiments, the unfused build material is dissolved or solubilized using a solvent that is at a temperature of greater than 40° C. In some embodiments, a surfactant is used to at least partially dissolve or solubilize unfused build material. In some embodiments, an ultrasonic cleaning bath is used to at least partially dissolve or solubilize unfused build material. Any of the processing after printing procedures within this paragraph may be combined.

In some embodiments, an additive manufacturing system described herein is capable of 10 producing a desired object having a surface roughness of such a degree that the desired object is generally considered safe to contact food. In some embodiments, an additive manufacturing system described herein is capable of producing a desired object having an Ra roughness of less than 5 μm, 3 μm, 1 μm, and/or 0.8 μm.

### Enumerated Embodiments

1. An additive manufacturing system comprising at least one microinductor and at least one build material comprising at least one fusible material.
2. The additive manufacturing system of embodiment 1, capable of depositing thin layers of at least one build material, in the form of a powder or particles, within the build volume.
3. The additive manufacturing system of embodiments 1 or 2, wherein a computer system controls the deposition of the layers of build material.
4. The additive manufacturing system of any one of embodiments 1-3, further comprising at least one extrusion nozzle.
5. The additive manufacturing system of any one of embodiments 1-4, wherein the at least one microinductor is present in a microinductor array having at least 20 microinductors.
6. The additive manufacturing system of any one of embodiments 1-5, wherein the fusible build material comprises at least one composition of particles, wherein the particles comprise an induction-conducive material.
7. The additive manufacturing system of any one of embodiments 1-6, wherein the fusible build material comprises metallic particles, wherein one or more compositions of particles are present, and the metallic particles are present within a binder.
8. The additive manufacturing system of embodiment 7, wherein the binder comprises a polymeric material, an inorganic material, or a wax.
9. The additive manufacturing system of any one of embodiments 7-8, wherein the binder comprises a polymeric material.
10. The additive manufacturing system of any one of embodiments 7-9, wherein the binder comprises polylactic acid.
11. The additive manufacturing system of any one of embodiments 7-10, wherein the majority of the metallic particles comprise at least one of aluminum, aluminum bronze, brass, admiralty brass, chromium, copper, gold, Inconel, iron, cast iron, lead, molybdenum, nickel, platinum, silver, sterling silver, steel, carbon steel, stainless steel, titanium, tungsten, zinc, tin, babbitt, vanadium, beryllium, beryllium copper, bismuth, cadmium, cobalt, magnesium, manganese, manganese bronze, mercury, palladium, rhodium, silicon, niobium, tantalum, carbon, sulfur, phosphorus, zirconium, rhenium, yttrium, hafnium, and boron.
12. The additive manufacturing system of any one of embodiments 7-11, wherein the majority of the metallic particles are made up of a steel alloy.
13. The additive manufacturing system of any one of embodiments 7-12, wherein the metallic particles are 50 nm to 100 μm in average diameter.
14. The additive manufacturing system of any one of embodiments 7-13, wherein the metallic particles are 15 μm to 85 μm in average diameter.
15. The additive manufacturing system of any one of embodiments 1-14, wherein the system further comprises a heated build volume.
16. The additive manufacturing system of any one of embodiments 1-15, wherein the build volume is at least partially filled with an inert gas.
17. The additive manufacturing system of embodiment 16, wherein the inert gas is at least one of: a noble gas, argon, and nitrogen.
18. The additive manufacturing system of any one of embodiments 1-17, wherein the gases within the build volume comprise at least one inert gas and less than 15% oxygen.
19. The additive manufacturing system of any one of embodiments 1-18, wherein the at least one microinductor fuses at least a portion of the build material while operating at a frequency of 3 kHz to 1.2 MHz.
20. The additive manufacturing system of any one of embodiments 1-19, wherein the at least one microinductor fuses at least a portion of the build material while operating at a frequency of 30 kHz to 400 kHz.
21. The additive manufacturing system of any one of embodiments 1-20, wherein at least two build materials are used for the completion of a single desired object.
22. The additive manufacturing system of any one of embodiments 1-21, wherein the presence of multiple build materials is useful to provide at least one of the following to a desired object: multiple material having differing material properties, multiple materials having multiple colors, or multiple materials wherein at least one material serves as a support material.
23. A method of additive manufacturing comprising the following steps:
   a) deposition of a build material through at least one extrusion nozzle;
   b) induction heating of a build material through the use of at least one microinductor;
   c) fusing of at least a portion of build material,
   wherein the build material comprises at least one fusible material.
24. The method of additive manufacturing of embodiment 23, wherein the at least one microinductor is present as microinductor array having at least 20 microinductors.
25. The method of additive manufacturing of embodiments 23-24, wherein the fusible build material comprises metallic particles, having at least one composition, in a binder.
26. The method of additive manufacturing of embodiment 25, wherein the binder comprises a polymeric material, an inorganic material, or a wax.
27. The method of additive manufacturing of embodiments 25-26, wherein the binder comprises a polymeric material.
28. The method of additive manufacturing of embodiments 25-27, wherein the binder comprises polylactic acid.
29. The method of additive manufacturing of embodiments 25-28, wherein the majority of the metallic particles comprise at least one of aluminum, aluminum bronze, brass, admiralty brass, chromium, copper, gold, Inconel, iron, cast iron, lead, molybdenum, nickel, platinum, silver, sterling silver, steel, carbon steel, stainless steel, titanium, tungsten, zinc, tin, babbitt, vanadium, beryllium, beryllium copper, bismuth, cadmium, cobalt, magnesium, manganese, manganese bronze, mercury, palladium, rhodium, silicon, niobium, tantalum, carbon, sulfur, phosphorus, zirconium, rhenium, yttrium, hafnium, and boron.
30. The method of additive manufacturing of embodiments 25-29, wherein the majority of the metallic particles are made up of a steel alloy.
31. The method of additive manufacturing of embodiments 25-30, wherein the metallic particles are 50 nm to 100 μm in average diameter.
32. The method of additive manufacturing of embodiments 25-31, wherein the metallic particles are 15 μm to 85 μm in average diameter.
33. The method of additive manufacturing of embodiments 23-32, wherein the system further comprises a heated build volume.
34. The method of additive manufacturing of embodiments 23-33, wherein the build volume is at least partially filled with an inert gas.
35. The method of additive manufacturing of embodiments 34, wherein the inert gas is at least one of: a noble gas, argon, and nitrogen.
36. The method of additive manufacturing of embodiments 23-35, wherein the gasses within the build volume comprise at least one inert gas and less than 15% oxygen.
37. The method of additive manufacturing of embodiments 23-36, wherein the at least one microinductor fuses at least a portion of the build material while operating at a frequency of 3 kHz to 1.2 MHz.
38. The method of additive manufacturing of embodiments 23-37, wherein the at least one microinductor fuses at least a portion of the build material while operating at a frequency of 30 kHz to 400 kHz.
39. The method of additive manufacturing of embodiments 23-38, wherein at least two build materials are used for the completion of a single desired object.
40. The method of additive manufacturing of embodiments 23-39, wherein the presence of multiple build materials is useful to provide at least one of the following to a desired object: multiple material having differing material properties, multiple materials having multiple colors, or multiple materials wherein at least one material serves as a support material.

### EXAMPLES

### Example 1: An Additive Manufacturing System using a Steel-Particle Fusible Build Material

A single extrusion printhead and a single microinductor printhead are present within an additive manufacturing system. The exterior support structure of the system is in the shape of a cube. The print bed is within the cube at the bottom and is not capable of movement along any axis. The print bed is 220 mm wide and 130 mm deep, with a useable printing area of 200 mm by 106 mm. The print bed is capable of being heated by a closed-loop system using ceramic heating elements. The two printheads are attached to a square-shaped gantry on the interior of the cube. This gantry is capable of vertical movement (movement in the z axis). The z axis height of the microinductor printhead, independent of the extrusion printhead, is manually adjustable. The extrusion printhead is capable of movement, independent from the other printhead, along the x and y axes. The microinductor printhead is capable of movement, independent from the other printhead, along only the y axis. The extrusion printhead is capable of movement in all 3 axes, and the microinductor printhead is capable of movement along 2 axes. Stepper motors are present for the positioning of both printheads and movement of filamentous build material. A computer control unit is connected to the outside of the cube support structure.

The extrusion printhead is a direct drive extruder, wherein rollers apply force to filamentous build material. This applied force causes the build material to enter the extrusion printhead and causes heated build material to be extruded through an extrusion nozzle. The internal diameter of the extrusion nozzle is 0.5 mm. The build material is heated at 250-270° C. within the extrusion printhead.

The microinductor printhead contains a 1-dimensional array of 2,496 individual induction heating elements over a distance of 106 mm. Two build materials are used within this additive manufacturing system. A first, fusible build material is made up of steel particles of 40 μm average diameter within a polymeric binder material, formed into a filament. A second, non-fusible build material contains clay particles within a polymeric binder material, formed into a filament. Both build materials are present on spools, and the build material filaments have an average diameter of 1.75 mm. The non-fusible build material may be used to produce heat-resistant support material. During printing, at least a portion of the steel particles within deposited build material is heated to 650-1300° C. After printing, unfused build material is removed by sandblasting.

### Example 2: A Microinductor Printhead Powder Bed Fusion Additive Manufacturing System

A single microinductor printhead is present within an additive manufacturing system. The exterior support structure of the system is in the shape of a cube. The print bed is within the cube at the bottom and is not capable of movement in any axis. The print bed is 220 mm wide and 220 mm deep, with a useable printing area of 200 mm by 200 mm. The print bed is capable of being heated by a closed-loop system using ceramic heating elements. The two printheads are attached to a square-shaped gantry on the interior of the cube. This gantry is capable of vertical movement (movement in the z axis). The printhead is capable of movement in all 3 axes. Stepper motors are present for the positioning of the printhead. A computer control unit is connected to the outside of the cube support structure.

Layers of build material powder, of a precise thickness, are deposited within the build volume by the action of a blade or roller. After each layer of build material is deposited, wherein fusion or induction heating is required, the microinductor printhead heats specific voxels of build material to fuse or heat these voxels. Fusion occurs within the desired voxels of build material when these voxels are heated, through induction heating, at temperatures of 650 to 1000° C.

The microinductor printhead contains a 1-dimensional array of 2,496 individual heating elements over a distance of 106 mm. The microinductor printhead is moved along two axes for the purpose of extending the area able to be fused by the printhead. The build material comprises bronze particles and polylactic acid polymer. After printing, unfused build material is removed by sandblasting.

While the foregoing written description enables one of ordinary skill to make and use what is considered presently to be the best mode thereof, those of ordinary skill will understand and appreciate the existence of variations, combinations, and equivalents of the specific embodiments, methods, and examples herein. The disclosure should therefore not be limited by the above-described embodiments, methods, and examples, but by all embodiments and methods within the scope and spirit of the disclosure.

1. An additive manufacturing system comprising at least one microinductor and at least one build material comprising at least one fusible material.

2. The additive manufacturing system of claim 1, capable of depositing thin layers of at least one build material, in the form of a powder or particles, within the build volume.

3. (canceled)

4. The additive manufacturing system of claim 1, further comprising at least one extrusion nozzle.

5. The additive manufacturing system of claim 1, wherein the at least one microinductor is present in a microinductor array having at least 20 microinductors.

6. The additive manufacturing system of claim 1, wherein the fusible build material comprises at least one composition of particles, wherein the particles comprise an induction-conducive material.

7. The additive manufacturing system of claim 1, wherein the fusible build material comprises metallic particles, wherein one or more compositions of particles are present, and the metallic particles are present within a binder.

8. The additive manufacturing system of claim 7, wherein the binder comprises a polymeric material, an inorganic material, or a wax.

9. The additive manufacturing system of claim 8, wherein the binder comprises a polymeric material.

10. The additive manufacturing system of claim 9, wherein the binder comprises polylactic acid.

11. The additive manufacturing system of claim 7, wherein the majority of the metallic particles comprise at least one of aluminum, aluminum bronze, brass, admiralty brass, chromium, copper, gold, Inconel, iron, cast iron, lead, molybdenum, nickel, platinum, silver, sterling silver, steel, carbon steel, stainless steel, titanium, tungsten, zinc, tin, babbitt, vanadium, beryllium, beryllium copper, bismuth, cadmium, cobalt, magnesium, manganese, manganese bronze, mercury, palladium, rhodium, silicon, niobium, tantalum, carbon, sulfur, phosphorus, zirconium, rhenium, yttrium, hafnium, and boron.

12. The additive manufacturing system of claim 11, wherein the majority of the metallic particles are made up of a steel alloy.

13. The additive manufacturing system of claim 7, wherein the metallic particles are 50 nm to 100 μm in average diameter.

14. The additive manufacturing system of claim 13, wherein the metallic particles are 15 μm to 85 μm in average diameter.

15. The additive manufacturing system of claim 1, wherein the system further comprises a heated build volume.

16. The additive manufacturing system of claim 1, wherein the build volume is at least partially filled with an inert gas.

17. The additive manufacturing system of claim 16, wherein the inert gas comprises at least one of: a noble gas, argon, and nitrogen.

18. The additive manufacturing system of claim 16, wherein the gases within the build volume comprise at least one inert gas and less than 15% oxygen.

19. The additive manufacturing system of claim 1, wherein the at least one microinductor fuses at least a portion of the build material while operating at a frequency of 3 kHz to 1.2 MHz.

20. The additive manufacturing system of claim 1, wherein the at least one microinductor fuses at least a portion of the build material while operating at a frequency of 30 kHz to 400 kHz.

21. The additive manufacturing system of claim 1, wherein at least two build materials are used for the completion of a single desired object.

22-40. (canceled)
